(19) United States
(12) Patent Application Publication
(10) Pub. No.: US 2022/0135792 A1
(43) Pub. Date: May 5, 2022

(54) BIO-RESIN COMPOSITION, BIO-RESIN COMPOSITE, AND BIO-FOAM MATERIAL

(71) Applicant: Industrial Technology Research Institute, Hsinchu (TW)

(72) Inventors: Sheng-Ju Liao, Hsinchu City (TW); Sheng-Lung Chang, Taoyuan City (TW); Shun-Wen Cheng, Tainan City (TW); Yu-Ting Liu, Hsinchu County (TW); Shihn-Juh Liou, Hsinchu City (TW)

(73) Assignee: Industrial Technology Research Institute, Hsinchu (TW)

(21) Appl. No.: 17/517,663

(22) Filed: Nov. 2, 2021

Related U.S. Application Data
(60) Provisional application No. 63/109,324, filed on Nov. 3, 2020.

(30) Foreign Application Priority Data
Jul. 8, 2021 (TW) 110125183

(51) Int. Cl. C08L 67/04; C08K 3/04; C08G 63/183; C08G 63/08

(52) U.S. Cl. CPC C08L 67/04; C08K 3/042; C08L 2203/14; C08G 63/183; C08G 63/08; C08K 3/041

(57) ABSTRACT

A bio-resin composition, a bio-resin composite, and a bio-foam material are provided. The bio-resin composition includes a polymer matrix, a toughener, and an antistatic agent. The weight ratio of the polymer matrix to the toughener is between 90:10 and 60:40. Based on the total weight of the polymer matrix and the toughener, the content of the antistatic agent is between 1% and 10%.

### CROSS-REFERENCE TO RELATED APPLICATION

This application claims the priority benefit of U.S. Provisional Application No. 63/109,324, filed on Nov. 3, 2020 and Taiwan Application No. 110125183, filed on Jul. 8, 2021. The entirety of each of the above-mentioned patent applications is hereby incorporated by reference herein and made a part of this specification.

### TECHNICAL FIELD

The disclosure relates to a resin composition, a resin composite, and a foam material.

### BACKGROUND

A general material with an antistatic property is obtained by mixing a resin composition containing an antistatic agent. The antistatic agent contained therein forms a conductive path in the resin, so that the formed composite has the antistatic property.

However, for the resin composite containing the antistatic agent, after foaming, the antistatic agent dispersed in the resin tend to be more dispersed due to the increase in volume of the resin, which destroys the conductive path in the original composite, so the antistatic effect of the foam material is reduced. In order to solve the issue, it is necessary to increase the content of the antistatic agent to improve conductivity, which not only increases the cost of the foam material, but also causes a decrease in mechanical properties and the lower expansion ratios.

### SUMMARY

The disclosure provides a bio-resin composition, which includes a polymer matrix, a toughener, and an antistatic agent.

The disclosure provides a bio-resin composite. The antistatic agent is present at an interface between the polymer matrix and the toughener and/or is present in the toughener.

The disclosure provides a bio-foam material, which is formed by the bio-resin composite undergoing a foaming process.

The bio-resin composite of the disclosure includes a polymer matrix, a toughener, and an antistatic agent. The toughener is dispersed in the polymer matrix. The antistatic agent is present at an interface between the polymer matrix and the toughener and/or is present in the toughener. A weight ratio of the polymer matrix to the toughener is between 90:10 and 60:40. Based on a total weight of the polymer matrix and the toughener, a content of the antistatic agent is between 1% and 10%.

The bio-foam material of the disclosure includes a bio-resin composite and is a foaming process product of the bio-resin composite. The bio-resin composite includes a polymer matrix, a toughener, and an antistatic agent. The toughener is dispersed in the polymer matrix. The antistatic agent is present at an interface between the polymer matrix and the toughener and/or is present in the toughener. A weight ratio of the polymer matrix to the toughener is between 90:10 and 60:40. Based on a total weight of the polymer matrix and the toughener, a content of the antistatic agent is between 1% and 10%.

The bio-resin composition of the disclosure includes a polymer matrix, a toughener, and an antistatic agent. A weight ratio of the polymer matrix to the toughener is between 90:10 and 60:40. Based on a total weight of the polymer matrix and the toughener, a content of the antistatic agent is between 1% and 10%.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a transmission electron microscope image of a bio-foam material of Experimental Example 2.

FIG. 2 is a transmission electron microscope image of a bio-foam material of Experimental Example 3.

### DETAILED DESCRIPTION OF DISCLOSED EMBODIMENTS

The following embodiments are listed in conjunction with the accompanying drawings for detailed description, but the embodiments are not intended to limit the scope covered by the disclosure.

Terms such as “contain”, “include”, and “have” mentioned in the disclosure are all open terms, which indicate “containing but not limited to”.

In addition, in the disclosure, a range represented by “a value to another value” is a general way of expression to avoid listing all values in the range one by one in the specification. Therefore, the recitation of a specific numerical range covers any value in the numerical range, and covers a smaller numerical range defined by any value in the numerical range.

A bio-resin composition of the embodiment of the disclosure includes a polymer matrix, a toughener, and an antistatic agent. In addition, in a bio-resin composite formed by the bio-resin composition, the toughener is dispersed in the polymer matrix, and the antistatic agent is present at an interface between the polymer matrix and the toughener and/or is present in the toughener. In this way, the antistatic agent may be distributed in a continuous phase manner at the interface between the polymer matrix and the toughener and/or in the toughener. Furthermore, since the antistatic agent may be distributed in a continuous phase manner at the interface between the polymer matrix and the toughener and/or in the toughener, when the bio-resin composite of the embodiment of the disclosure undergoes a foaming process, a conductive path formed by the antistatic agent in the formed bio-foam material is not easily destroyed. Therefore, the bio-foam material of the embodiment of the disclosure may have good electrical conductivity and antistatic property. The bio-resin composition, the bio-resin composite, and the bio-foam material of the embodiments of the disclosure will be described below.

The bio-resin composition of the embodiment of the disclosure includes the polymer matrix, the toughener, and the antistatic agent. In the embodiment of the disclosure, the polymer matrix is, for example, polylactic acid (PLA), and the melt flow index (MI) is, for example, between 2 g/10 min@190° C. to 10 g/10 min@190° C. In addition, the toughener is, for example, polycaprolactone (PCL), polybutylene succinate (PBS), polybutylene adipate terephthalate (PBAT), or a combination thereof, and the melt flow index is between 15 g/10 min@190° C. and 120 g/10 min@190° C. In an embodiment, the melt flow index of the toughener is, for example, between 15 g/10 min@190° C. and 100 g/10 min@190° C. In another embodiment, the melt flow index of the toughener is, for example, between 15 g/10 min@190° C. and 80 g/10 min@190° C. In another embodiment, the melt flow index of the toughener is, for example, between 15 g/10 min@190° C. and 50 g/10 min@190° C. In other words, in the embodiment of the disclosure, the flow characteristic of the toughener is higher than the flow characteristic of the polymer matrix.

In addition, in the bio-resin composition of the embodiment of the disclosure, the weight ratio of the polymer matrix to the toughener is between 90:10 and 60:40. When the weight ratio of the polymer matrix to the toughener is outside the above range, the rigidity of the material decreases and a foam material with higher expansion ratios cannot be obtained.

In the embodiment of the disclosure, the antistatic agent includes carbon black, carbon nanotube, graphene, or a combination thereof. The antistatic agent has good electrical conductivity, so that the bio-resin composite formed by the bio-resin composition of the embodiment of the disclosure and the bio-foam material formed by the bio-resin composite have good antistatic properties to be used in the packaging of electronic precision instruments, high-end panels, glass substrates, and semiconductor products with antistatic requirements to protect and maintain the functions of the electronic products. In the embodiment of the disclosure, based on the total weight of the polymer matrix and the toughener, the content of the antistatic agent is, for example, between 1% and 10%. When the content of the antistatic agent is less than 1%, after the bio-resin composite formed by the bio-resin composition undergoes the foaming process to form the bio-foam material, the conductive path formed by the anti-static agent in the bio-foam material is destroyed due to the increase in volume during foaming. When the content of the antistatic agent is higher than 10%, granulation cannot be smoothly compounded and extruded, the mechanical performance is significantly reduced, and it is difficult to obtain the foam material with the high expansion ratios. In an embodiment, based on the total weight of the polymer matrix and the toughener, the content of the antistatic agent is, for example, between 1% and 5%.

In addition, in the embodiment of the disclosure, the flow characteristic of the toughener is higher than the flow characteristic of the polymer matrix. Therefore, in the bio-resin composite formed by the bio-resin composition of the embodiment of the disclosure, the antistatic agent is mainly present at the interface between the polymer matrix and the toughener and/or is present in the toughener, and is distributed in a continuous phase manner to form the conductive path, and after forming the bio-foam material, a complete conductive path may still be maintained to provide good antistatic property. In the embodiment of the disclosure, the surface impedance of the bio-resin composite is, for example, between 10⁵ Ω/sq and 10⁷ Ω/sq.

In an embodiment, a twin screw extruder may be used to perform melting and mixing, reactive extrusion, and bracing granulation on the bio-resin composition of the embodiment of the disclosure to produce the bio-resin composite.

The bio-resin composite of the embodiment of the disclosure undergoes the foaming reaction (for example, a supercritical batch foaming process) to form the bio-foam material of the embodiment of the disclosure, which may be foamed to have a volume of 10 times to 30 times. In the embodiment of the disclosure, the diameter of a cell of the bio-foam material is, for example, between 1 μm and 100 μm, and the density thereof is, for example, between 0.02 g/cm³ and 0.2 g/cm³. In an embodiment, the density of the bio-foam material is, for example, between 0.02 g/cm³ and 0.15 g/cm³. In addition, the surface impedance of the formed bio-foam material is, for example, between 10⁴ Ω/sq and 10⁷ Ω/sq. In other words, after undergoing the foaming process compared with the bio-resin composite, the bio-foam material may have the same or even lower surface impedance, so as to have good antistatic property.

Hereinafter, experimental examples and comparative examples will be used to describe the bio-resin composite of the disclosure and the bio-foam material formed by the bio-resin composite after the foaming process.

### Experimental Example 1

90 wt. % of polylactic acid (with a melt flow index of 4.3) was used as the polymer matrix, and 10 wt. % of polycaprolactone (with a melt flow index of 45) was added as the toughener and 5 phr of carbon nanotube was added as the antistatic agent to prepare the bio-resin composition.

Then, a twin screw extruder (the temperature was set to a gradient from 120° C. to 190° C., the rotation speed was set from 60 rpm to 300 rpm, and the aspect ratio was set from 28 to 60) was used to perform melting and mixing, reactive extrusion, and bracing granulation on the bio-resin composition to produce the bio-resin composite (with a surface impedance of 10⁵ Ω/sq and a density of 1.256 g/cm³).

After that, the bio-resin composite was dried at a temperature of 50° C. to 80° C. for 8 hours to 12 hours. Then, a supercritical batch foaming machine and a gas with a carbon dioxide content of 70% to 100% were used, and the bio-resin composite undergoes the foaming reaction at a temperature of 90° C. to 140° C. and a gas pressure of 1500 psi to 3500 psi to form the bio-foam material (with a surface impedance of 10⁵ Ω/sq and a density of 0.053 g/cm³).

According to ASTM D257, the surface impedance test of the bio-resin composite and the foam material thereof is performed.

### Experimental Example 2

In addition to using 80 wt. % of polylactic acid (with a melt flow index of 4.3), 20 wt. % of polycaprolactone (with a melt flow index of 45), and 1 phr of carbon nanotube, the same manner as in Experimental Example 1 was used to form the bio-resin composite (with a surface impedance of 10⁷ Ω/sq and a density of 1.228 g/cm³) and the bio-foam material (with a surface impedance of 10⁵ Ω/sq and a density of 0.066 g/cm³).

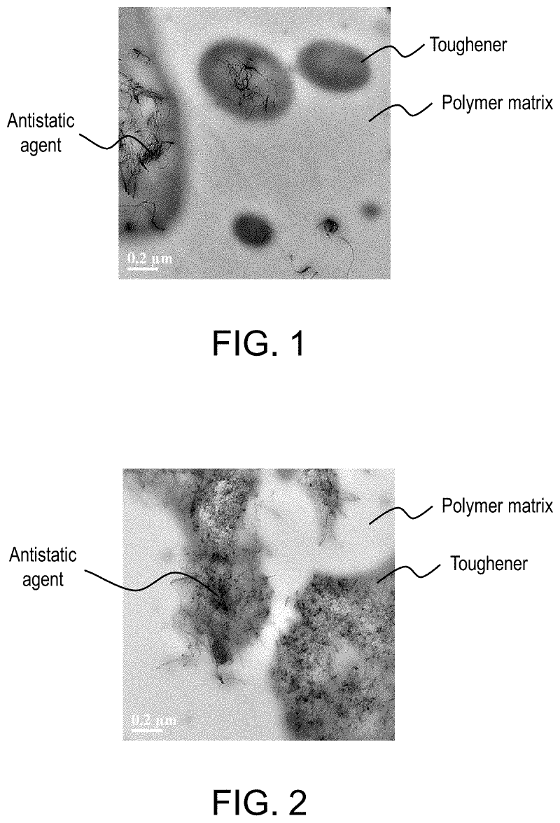

FIG. 1 is a transmission electron microscope image of the bio-foam material of Experimental Example 2. It can be seen from FIG. 1 that the antistatic agent is present at the interface between the polymer matrix and the toughener and is present in the toughener, and is distributed in a continuous phase manner.

### Experimental Example 3

In addition to using 80 wt. % of polylactic acid (with a melt flow index of 4.3), 20 wt. % of polycaprolactone (with a melt flow index of 45), and 3 phr of carbon nanotube, the same manner as in Experimental Example 1 was used to form the bio-resin composite (with a surface impedance of 10⁵ Ω/sq and a density of 1.236 g/cm³) and the bio-foam material (with a surface impedance of 10⁵ Ω/sq and a density of 0.057 g/cm³). In addition, the diameter of the cell of the bio-foam material is between 40 μm and 60 μm.

FIG. 2 is a transmission electron microscope image of the bio-foam material of Experimental Example 3. It can be seen from FIG. 2 that the antistatic agent is present at the interface between the polymer matrix and the toughener and is present in the toughener, and is distributed in a continuous phase manner.

### Experimental Example 4

In addition to using 80 wt. % of polylactic acid (with a melt flow index of 4.3), 20 wt. % of polycaprolactone (with a melt flow index of 45), and 5 phr of carbon nanotube, the same manner as in Experimental Example 1 was used to form the bio-resin composite (with a surface impedance of 10⁵ Ω/sq and a density of 1.251 g/cm³) and the bio-foam material (with a surface impedance of 10⁵ Ω/sq and a density of 0.069 g/cm³).

### Experimental Example 5

In addition to using 70 wt. % of polylactic acid (with a melt flow index of 4.3), 30 wt. % of polycaprolactone (with a melt flow index of 45), and 5 phr of carbon nanotube, the same manner as in Experimental Example 1 was used to form the bio-resin composite (with a surface impedance of 10⁵ Ω/sq to 10⁶ Ω/sq and a density of 1.230 g/cm³) and the bio-foam material (with a surface impedance of 10⁵ Ω/sq to 10⁶ Ω/sq and a density of 0.079 g/cm³).

### Experimental Example 6

In addition to using 60 wt. % of polylactic acid (with a melt flow index of 4.3), 40 wt. % of polycaprolactone (with a melt flow index of 45), and 5 phr of carbon nanotube, the same manner as in Experimental Example 1 was used to form the bio-resin composite (with a surface impedance of 10⁵ Ω/sq to 10⁶ Ω/sq and a density of 1.221 g/cm³) and the bio-foam material (with a surface impedance of 10⁴ Ω/sq to 10⁵ Ω/sq and a density of 0.125 g/cm³).

### Experimental Example 7

In addition to using 90 wt. % of polylactic acid (with a melt flow index of 4.3), 10 wt. % of polybutylene succinate (with a melt flow index of 30), and 5 phr of carbon nanotube, the same manner as in Experimental Example 1 was used to form the bio-resin composite (with a surface impedance of 10⁶ Ω/sq and a density of 1.269 g/cm³) and the bio-foam material (with a surface impedance of 10⁵ Ω/sq and a density of 0.085 g/cm³).

### Experimental Example 8

In addition to using 80 wt. % of polylactic acid (with a melt flow index of 4.3), 20 wt. % of polybutylene adipate terephthalate (with a melt flow index of 18), and 3 phr of carbon nanotube, the same manner as in Experimental Example 1 was used to form the bio-resin composite (with a surface impedance of 10⁶ Ω/sq to 10⁷ Ω/sq and a density of 1.257 g/cm³) and the bio-foam material (with a surface impedance of 10⁶ Ω/sq to 10⁷ Ω/sq and a density of 0.064 g/cm³).

### Comparative Example 1

In addition to using 100 wt. % of polylactic acid (with a melt flow index of 4.3) without using the toughener and using 1 phr of carbon nanotube, the same manner as in Experimental Example 1 was used to form the bio-resin composite (with a surface impedance of 10⁷ Ω/sq to 10⁸ Ω/sq and a density of 1.169 g/cm³) and the bio-foam material (with a surface impedance of 10¹² Ω/sq and a density of 0.027 g/cm³).

### Comparative Example 2

In addition to using 100 wt. % polylactic acid (with a melt flow index of 4.3) without using the toughener and using 3 phr of carbon nanotube, the same manner as in Experimental Example 1 was used to form the bio-resin composite (with a surface impedance of 10⁶ Ω/sq to 10⁷ Ω/sq and a density of 1.179 g/cm³) and the bio-foam material (with a surface impedance of 10⁷ Ω/sq to 10⁹ Ω/sq and a density of 0.023 g/cm³).

It can be seen from Experimental Example 1 to Experimental Example 8, Comparative Example 1, and Comparative Example 2 that when the bio-resin composite contains the toughener, the antistatic agent may be present at the interface between the polymer matrix and the toughener and/or may be present in the toughener, and is distributed in a continuous phase manner. Therefore, after performing the foaming process to form the bio-foam material, the formed bio-foam material may have the same or even lower surface impedance, so as to have good antistatic property.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A bio-resin composite, comprising:
a polymer matrix;
a toughener, dispersed in the polymer matrix; and
an antistatic agent, present at an interface between the polymer matrix and the toughener and/or present in the toughener, wherein
a weight ratio of the polymer matrix to the toughener is between 90:10 and 60:40, and based on a total weight of the polymer matrix and the toughener, a content of the antistatic agent is between 1% and 10%.

2. The bio-resin composite according to claim 1, wherein the polymer matrix comprises polylactic acid.

3. The bio-resin composite according to claim 1, wherein the toughener comprises polycaprolactone, polybutylene succinate, polybutylene adipate terephthalate, or a combination thereof.

4. The bio-resin composite according to claim 1, wherein the antistatic agent comprises carbon black, carbon nanotube, graphene, or a combination thereof.

5. The bio-resin composite according to claim 1, wherein a melt flow index of the polymer matrix is between 2 g/10 min@190° C. and 10 g/10 min@190° C., and a melt flow index of the toughener is between 15 g/10 min@190° C. and 120 g/10 min@190° C.

6. The bio-resin composite according to claim 1, wherein based on the total weight of the polymer matrix and the toughener, the content of the antistatic agent is between 1% and 5%.

7. A bio-foam material, comprising a bio-resin composite and being a product of the bio-resin composite after foaming, wherein the bio-resin composite comprises:
a polymer matrix;
a toughener, dispersed in the polymer matrix; and
an antistatic agent, present at an interface between the polymer matrix and the toughener and/or present in the toughener, wherein
a weight ratio of the polymer matrix to the toughener is between 90:10 and 60:40, and based on a total weight of the polymer matrix and the toughener, a content of the antistatic agent is between 1% and 10%.

8. The bio-foam material according to claim 7, wherein the polymer matrix comprises polylactic acid.

9. The bio-foam material according to claim 7, wherein the toughener comprises polycaprolactone, polybutylene succinate, polybutylene adipate terephthalate, or a combination thereof.

10. The bio-foam material according to claim 7, wherein the antistatic agent comprises carbon black, carbon nanotube, graphene, or a combination thereof.

11. The bio-foam material according to claim 7, wherein a melt flow index of the polymer matrix is between 2 g/10 min@190° C. and 10 g/10 min@190° C., and a melt flow index of the toughener is between 15 g/10 min@190° C. and 120 g/10 min@190° C.

12. The bio-foam material according to claim 7, wherein based on the total weight of the polymer matrix and the toughener, the content of the antistatic agent is between 1% and 5%.

13. The bio-foam material according to claim 7, wherein a surface impedance of the bio-foam material is between 10⁴ Ω/sq and 10⁷ Ω/sq.

14. The bio-foam material according to claim 7, wherein a density of the bio-foam material is between 0.02 g/cm³ and 0.2 g/cm³.

15. A bio-resin composition, comprising:
a polymer matrix;
a toughener; and
an antistatic agent, wherein
a weight ratio of the polymer matrix to the toughener is between 90:10 and 60:40, and based on a total weight of the polymer matrix and the toughener, a content of the antistatic agent is between 1% and 10%.

16. The bio-resin composition according to claim 15, wherein the polymer matrix comprises polylactic acid.

17. The bio-resin composition according to claim 15, wherein the toughener comprises polycaprolactone, polybutylene succinate, polybutylene adipate terephthalate, or a combination thereof.

18. The bio-resin composition according to claim 15, wherein the antistatic agent comprises carbon black, carbon nanotube, graphene, or a combination thereof.

19. The bio-resin composition according to claim 15, wherein a melt flow index of the polymer matrix is between 2 g/10 min@190° C. and 10 g/10 min@190° C., and a melt flow index of the toughener is between 15 g/10 min@190° C. and 120 g/10 min@190° C.

20. The bio-resin composition according to claim 15, wherein based on the total weight of the polymer matrix and the toughener, the content of the antistatic agent is between 1% and 5%.
